(19) United States
(12) Patent Application Publication
(10) Pub. No.: US 2019/0084191 A1
(43) Pub. Date: Mar. 21, 2019

(54) Method for Producing Drive Belts

(71) Applicant: Walther Flender GmbH, Duesseldorf (DE)

(72) Inventors: Andreas SCHOLZEN, Moers (DE); Simon-Martin SCHMIDT, Duesseldorf (DE)

(21) Appl. No.: 16/082,370

(22) PCT Filed: Dec. 23, 2016
(86) PCT No.: PCT/EP2016/082642

§ 371 Date: Sep. 5, 2018

(30) Foreign Application Priority Data
Mar. 7, 2016 (DE) 10 2016 104 124.6

(51) Int. Cl. B29C 33/30; B29C 45/26; B29C 70/54; B29D 29/08; F16G 1/08; F16G 1/28; F16G 5/06; F16G 5/20

(52) U.S. Cl. CPC B29C 33/302; B29C 45/2673; B29C 70/541; F16G 5/20; F16G 1/08; F16G 1/28; F16G 5/06; B29D 29/08

(57) ABSTRACT

The invention relates to a method for producing drive belts from different materials by means of casting processes. To this end, a mould core and an outer mould of a casting tool are provided. The circumferential surface of the mould core or the inner circumferential surface of the outer mould is provided with a geometry to be represented on the drive belt. A textile layer is laid on the geometry. The mould core is set into the outer mould so that the mould core and the outer mould define a cavity between them. Optionally, a tension member can be arranged in the cavity and the cavity can be sealed with respect to the environment at least in the region of the geometry to be represented on the drive belt. The textile layer is applied to the surfaces defining the geometry and an elastomer base material is introduced into the cavity.

The invention relates to a method for producing drive belts.

### PRIOR ART

A representation of the different approaches known from the prior art when producing drive belts in general and synchronous belts specifically is found in DE 10 2013 104 764 A1. In further development of the prior art for the manufacture of a belt with embedded tension members, a method is proposed there in which a tension member is subjected to an upstream preparation. The belt comprises a belt body consisting of a polyurethane with elastic properties which has a cover layer as a belt backing and a substructure with a force transfer area and a tension member embedded in the belt body and which is prepared with polyurethane. A reproducible polymer filling of the tension member hollow spaces and associated high process security should be ensured by that in an upstream method step of the belt manufacture, tension member hollow spaces of the tension member are filled at least partly with the polyurethane by wetting the tension member in a single preparation step or in at least two preparation steps with a preparation mixture comprising the polyurethane or its starting components and at least one solvent or dispersant and the prepared tension member is then dried, the polyurethane to fill the tension member hollow spaces being the same as the polyurethane of the belt body. Through this manner of manufacture, uniform wetting of all tension member fibres, including the innermost tension member fibres and good binding of the tension member to the belt body is supposed to be achieved.

The manufacture of synchronous belts is also described in a general form for example in Raimund Perneder “Handbook of Timing Belt Technology”, Springer Verlag Berlin Heidelberg, 2009, ISBN 978-3-540-89321-9, page 29-35.

Accordingly, two different base materials dominate for closed synchronous belts which, in turn, require different production methods.

a) Synchronous belts based on synthetic rubber

The first base material is synthetic rubber from which vulcanised synchronous belts are produced.

The belts consists of an elastomer (synthetic rubber such as chloroprene rubber (CR), hydrogenated acrylonitrile butadiene rubber (HNBR) or ethylene propylene diene rubber (EPDM)), a tension member (mainly glass fibres, alternative fibres, strands or wires made of aramid, carbon or steel) and a polyamide fabric on the toothed side. The fabric reduces the wear and increases the shear strength of the teeth.

The production of each discrete synchronous belt length requires a separate mould. The fabric is firstly drawn into the shape of an endless stocking via this mould. A single or two parallel tension members are then coiled around the fabric in a spiral shape over the mould width. The tensile force in the tension member fixes the fabric and determines the subsequent length of the finished belt. The thickness of the fabric also determines the position of the tension member in the belt.

The elastomer is wound around the tension member as the third layer. The mould prepared in this manner is inserted in a vulcanisation vessel. The teeth are formed through the effect of pressure and temperature and the cross-linking of the rubber takes place by vulcanisation. The elastomer flows between the tension members due to the pressure and fills the tooth spaces. The viscosity is set such that the material flows between the tension members, but cannot penetrate the fabric. The fabric is thus elongated and pressed into the spaces.

These belts are always produced with fabric. The back of the belts is often ground to smooth out irregularities and to achieve uniform back thickness.

### b) Synchronous Belts Based on Cast Polyurethane

The second material is cast polyurethane (PU).

In the production of synchronous belts from polyurethanes cast polyurethanes made of two or more components are usually used.

In general, steel tension members are embedded into the PU matrix for force transfer. Aramid is also possible. Glass fibre has not been used to a notable extent in these belts up to now.

Even during the production of synchronous belts made of PU, each discrete synchronous belt length requires a separate mould. The core is wound with the steel tension member. The outer mould is filled with a defined amount of PU. The wound core is introduced into the outer mould and the PU displaced through the penetrating core (displacement casting). The air escapes upwards.

In a further method variant, the wound core is firstly introduced into the mould and then PU is injected from below. The PU then rises slowly from below upwards in the mould. The aim is always the air displacement from below upwards to avoid air pockets in the PU. In addition, a vacuum can be used to support this operation.

Centrifugal casting should be mentioned as another method for producing synchronous belts with a PU matrix in which the flowable plastic is placed into the mould of the synchronous belt by utilising rotational forces.

A particularity of the previously-mentioned approaches is the so-called coiling noses which have to be present on the mould to guide the tension members. The coiling noses determine the position of the tension members in the finished synchronous belts. Without the coiling noses, the tension members would rest on the heads of the synchronous belt mould. Elastomer could not flow between tension member and tooth head. In the finished belts, the tension members would lay open in the tooth intermediate spaces and would come into direct contact with the belt disc depending on the profile coverage which would result in significant wear.

With the aid of the coiling noses, there is always a thin PU layer between steel tension member and disc head. Nevertheless there remains a line in the tooth space, caused by the contact of the tension member on the coiling nose which does not receive direct contact with the disc, but still allows the penetration of any damaging foreign media (moisture, chemicals, etc.) and thus forms a potential source of premature damage to the belt.

An inherent disadvantage of the previously-explained known production processes is that during the production process it is not possible using these methods to equip the belt to be produced on its tooth side with a fabric layer shaped in the process itself. Even a subsequent application of the fabric for example by adhesion is not readily possible since the tooth geometry would be unreliably changed as a result. A premoulded fabric layer can at best be introduced into the respective mould. The effort required for the moulding and the introduction of such a fabric layer is, however, considerable.

Glass fibre tension members or similarly break-prone fibres are also not used in conventionally-produced belts because the sensitive filaments have to be drawn over the coiling noses under a pretensioning force when demoulding the belt whereby they could be damaged.

### c) Further Methods

In addition to the two previously-mentioned materials and methods dominating the practice, it has also been proposed to produce synchronous belts by injection moulding.

A particular challenge is posed by the production of synchronous belts, which have a polyurethane matrix (duroplast or themoplast), into which tension members based on fibres, such as tension members based on glass or high-performance fibres are embedded and which have a tooth-side fabric.

In order to optimise the bending fatigue strength of synchronous belts of the type mentioned here, the use of fibres, in particular glass fibres, high-performance fibres or the like, would, however, be desirable.

A fabric between tension member and belt mould would also further optimise the use properties of synchronous belts made of PU (polyurethane) and make the coiling noses superfluous.

The aim of the invention was to enable a simplified production of drive belts, in particular synchronous belts. In this case, the method according to the invention should optimally allow drive belts, in particular synchronous belts to also be produced from alternative materials such as rubber materials, for example, natural rubber or synthetic rubber, materials based on silicon and any other further alternative plastic material which is suitable for belt production by means of using casting methods.

The invention proposes for this purpose the method indicated in claim 1 by means of which drive belts, in particular synchronous belts can be produced in a particularly economic and technologically optimised manner.

Advantageous configurations of the invention are indicated in the dependent claims and in the following description in which the general inventive concept is also explained further.

The method according to the invention for producing a synchronous belt accordingly has at least the following work steps:
a) providing a mould core and an outer mould of a casting tool, the mould core being provided to be inserted into the outer mould such that a cavity representing the shape of the drive belt to be produced is formed between the outer mould and the mould core sitting therein, and the circumferential surface of the mould core assigned to the cavity or the inner circumferential surface of the outer mould assigned to the cavity being provided with a geometry to be represented on the drive belt which is formed by recesses or protrusions which are delimited by surfaces abutting one another which are formed into the circumferential surface of the mould core or the inner circumferential surface of the outer mould or formed on the circumferential surface of the mould core or the inner circumferential surface of the outer mould;
b) placing a textile layer on the geometry to be represented on the drive belt;
c) inserting the mould core into the outer mould so that the mould core and the outer mould define the cavity between them;
d) optionally: arranging a tension member in the cavity;
e) optionally: sealing the cavity at least in the region of the geometry to be represented on the drive belt with respect to the environment;
f) applying the textile layer on the surfaces which delimit on the mould core or on the outer mould the geometry to be represented on the drive belt, by generating an underpressure in the region of the free spaces which are present between the textile layer and the geometry after work step b);
g) introducing a castable elastomer base material into the cavity;
h) optionally: pressing base material after completely filling the cavity with the base material to effect a pressure increase in the cavity;
i) optionally: maintaining the pressure acting on the base material until the base material has become sufficiently hard;
j) demoulding the belt winding obtained.

If a measure, a work step or a feature is designated in the present text as “optional”, then this means that this measure, this work step or this feature is not necessarily a part of the invention, but can be optionally implemented in order to achieve the advantage or effect explained in connection with the affected optional measure, the affected optional work step or the affected optional feature.

The method according to the invention is equally suitable for the production of drive belts which have a closed shape, i.e. for example they are circular when they are not being used or which are not closed, i.e. they have a defined beginning and a defined end.

A casting tool with an outer mould and a mould core inserted into the outer mould is consequently used for the method according to the invention.

To this end, a mould core is prepared which is provided on its circumference with the geometry to be represented on the belt. In the event that a synchronous belt is supposed to be produced using the method according to the invention, this geometry is the negative of the tooth geometry to be represented on the belt. Alternatively or additionally, the geometry to be represented on the drive belt can also be formed on the inner circumferential surface of the outer mould of the casting tool assigned to the cavity.

In the case of the method according to the invention, a textile is placed on the geometry of the casting tool to be represented on the drive belt. In the event that the geometry to be represented on the drive belt is a tooth geometry, the textile is placed for this purpose around the mould core or on the outer mould such that the fabric layer is supported on the tooth end surfaces of the tooth geometry of the mould core or the outer mould.

Here, all structures provided for technical purposes and extending flatly which are produced from threads or fibres connected to one another are understood as textiles. These include fabrics produced by weaving methods which are particularly suitable for the purposes according to the invention. However, knitted fabric, crocheted fabric, laid fabrics and all other textiles can be used which fulfil the purpose of the textile layer provided according to the invention in the finished drive belt produced according to the invention.

The mould core is placed into the outer mould representing the outer shape of the drive belt prior to or after placing the textile layer such that the outer mould and the mould core delimit the cavity between them which determines the shape of the drive belt to be produced.

In particular when the application of the textile layer on the geometry to be represented on the drive belt is supposed to be supported by application with an underpressure, it may be expedient to tightly seal the cavity formed between the outer mould and the mould core with respect to the environment at least in the region in which the geometry to be represented on the drive belt is provided.

In order to support the application of the textile layer on the geometry to be represented on the drive belt, an underpressure can be generated at least in the region of the free spaces still present between the textile layer and the mould core. As a result of this optionally applied underpressure, the textile layer abuts on the surfaces which delimit the geometry to be represented on the drive belt. In the event of a tooth geometry to be represented on a synchronous belt, this is the flanks of the teeth of the tooth geometry of the mould core and the base surface of the tooth spaces present between the teeth of the tooth geometry at which the textile layer abuts on the geometry to be represented as a result of evacuating the free spaces present in the region of the tooth geometry to be represented.

Suction holes can be provided in the region of the geometry for the optional generation of the underpressure which end at the surfaces delimiting the geometry to be represented, in the event of a tooth geometry in particular at the tooth end or tooth flank surfaces of the teeth or at the base surfaces of the tooth spaces of the tooth geometry. The atmosphere present in the free spaces is suctioned via the suction holes, said atmosphere may typically be air. In this way, an underpressure results from the suction between the textile and the geometry to be represented through which the textile is suctioned onto the surfaces of the geometry and is thus held on the mould core or the outer mould.

The textile is optimally formed as tightly as possible and thus hardly air-permeable to airtight. In this way, the application, effected by means of evacuating the atmosphere, on the geometry to be represented can already be triggered in the case of comparably small-dimensioned suction flows or underpressures.

In order to optimise the binding of the textile layer to the base material of the base body of a drive belt according to the invention, the textile of the textile layer can be provided with a coating capable of reacting with the base material. In this way, an intensive, materially-bonded binding of the textile layer to the base material can be achieved. For this purpose, a material related to the base material is preferably used. If the base body is formed for example from a PU base material, it is expedient to also coat the coating of the textile of the textile layer or the textile layer as a whole with the same or an identical PU material which reacts with the base material when it is introduced into the cavity of the casting mould.

If a coating is applied to the textile layer or the textile forming this textile layer, it has in particular been proven to be particularly advantageous in the case where the application of the textile layer to the geometry to be represented on the drive belt is supposed to be supported by the application with an underpressure, when the textile layer is largely gas-tight due to the coating. The application of the textile on the geometry to be represented can also be supported by the textile being longitudinally elastic.

This has been proven in particular advantageous when the geometry to be covered with the textile and to be represented on the drive belt to be produced is formed on the mould core. Its longitudinal elasticity already allows the textile to be pretensioned to a certain degree when it is inserted into the mould and thus ensures that the textile already has a geometrically faultlessly determined shape in the inserted state. In spite of the pretension the elasticity inherent thereto allows the textile, as a result of the optional suctioning of the gases present in the region of the geometry, such as for example air, or the pressure exerted by the base material, to lengthen such that it rests faultlessly on the geometry of the mould core to be represented on the drive belt. This has proven particularly advantageous when the geometry to be represented is a tooth geometry.

The textile layer can be arranged on the geometry to be represented in a single or multi-layered manner in order to satisfy the stresses occurring in practice whilst taking into account the respective properties of the material used for the textile layer.

After the application, optionally supported by the application with an underpressure, on the geometry of the casting mould to be represented, the textile does not have to abut perfectly on the surfaces of the geometry to be represented on the drive belt, but rather merely be held there such that textile abuts at least in sections on each of the surfaces of the geometry to be represented to be covered with textile.

After the textile layer has been pre-positioned in the previously-explained manner on the surfaces of the mould core or the outer mould delimiting the geometry to be represented, the respective base material of the drive belt to be produced is injected into the cavity of the shaping tool comprising the mould core and the outer mould. The introduction of the base material is preferably carried out with pressures which are below the pressures that are common for conventional injection moulding of elastomers. Pressures of less than 100 bar are preferred for the method according to the invention. In practice, pressures of at most 50 bar, in particular of 2 to 50 bar, have been proven particularly suitable here, wherein particularly good filling results can be expected in practice from pressures which are less than 50 bar, such as up to 45 bar or up to 40 bar.

Insofar as gas, such as for example air was present in the cavity when introducing the base material, this is displaced by the base material and can escape via valves, outflow openings, balancing containers or the like that are provided for such purpose. Expelling the respective gas can be facilitated by at least one overflow region being provided on the casting mould into which excess base material introduced specifically into the cavity of the casting mould flows after the casting mould has been completely filled.

The base material penetrating into the cavity presses against the textile layer abutting on the geometry to be represented and ensures together with the optionally generated and similarly optionally maintained underpressure that the textile layer is pressed smoothly on the surfaces of the geometry assigned to it in a manner such that the textile layer also perfectly covers the transitions between the individual surfaces of the geometry. In this manner, it can also be ensured on comparatively complexly formed tooth geometries without significant effort that the surfaces delimiting the tooth geometry are evenly and precisely covered with the textile layer.

The even covering of the surfaces delimiting the geometry to be represented with the textile layer can also be supported by a pressure increase being optionally effected by additional base material being pressed into the cavity following complete filling of the cavity with the base material. This targeted pressure increase also optimally ensures the complete filling of the geometry to be represented on the drive belt with base material. This work step has therefore proven particularly appropriate in particular when filling tooth geometries to be represented on the belt to be produced.

The pressure respectively acting on the base material is maintained until the base material has become sufficiently hard.

If required, the belt undergoes an optionally additional temperature treatment to set its properties in a manner known per se.

The belt winding obtained is then demoulded.

In the event that the geometry of the drive belt to be represented is formed on the mould core, it is generated on the inside of the belt. However, it is equally possible for the geometry of the belt to firstly be formed on its outer back side. For example in the case of a tooth geometry, the toothing of the belt is then not represented by the mould core, but the tooth geometry formed on the outer mould. If required, the synchronous belt obtained can then be turned inside out after its production so that the previously outer toothing is present on the inside of the belt in the case of the product that is ready for sale or use.

Drive belts to be produced with the method according to the invention can be equipped with a tension member which absorbs the forces acting on the drive belt during practical use.

The pressure maintained after the mould filling, acting on the base material supports the tension member to be penetrated with the base material and thus reduces the inner friction of the individual filaments of which the tension member is constructed. Surprisingly, it has been shown that complete penetration of the tension member occurs in spite of the comparatively low injection pressures with the approach according to the invention and an optimal binding of the tension member to the base material is ensured without requiring particular effort such as a particular pre-coating or the like for this purpose. The intensive embedding of the tension member into the base material achieved in this manner improves the service life of synchronous belts produced according to the invention as a whole.

The approach according to the invention thus allows an optionally provided tension member to be placed in an uncoated state in the cavity of the casting mould and be embedded into the base material such that the tension member is intensively bound to the base material and can safely absorb the tensile forces loading the drive belt during operation. This, of course, does not exclude providing the tension member with a coating, for example an adhesive if this is expedient from a production point of view or is proven convenient based on the particularities of the material of the respectively used tension members for an optimal bonding. However, this effort does not have to be necessarily carried out for the production according to the invention of a drive belt in order to achieve a functional binding of the tension member to the base material of the drive belt. In any case, in the case of a production approach according to the invention, even when coated tension members are used, the penetration of the base material into the free spaces present between the individual tension member fibres or strands supports the binding of the tension member to the base body.

The optionally provided tension member is arranged in the cavity of the casting mould formed according to the invention.

To this end, it can be placed around the mould core prior to inserting the mould core (work step c)). If the tension member is present as an individual fibre, as a fibre strand, fibre bundle or in a strip shape, for example formed in the manner of a textile strip, the tension member is wound around the mould core in one or more layers for this purpose. The tension member is hereby preferably placed around the mould core in a spiral shape. By the tension member being thereby arranged on the mould core in the manner of a screw thread with a course inclined in relation to the longitudinal axis of the mould core, the tension member can be placed uninterrupted around the mould core and can ensure an optimal effect in the drive belt to be produced. In order to adapt the loadability of the tension member layer to the stresses occurring during practical use, the tension members can be arranged in the cavity of the casting mould, if necessary in a single or multi-layered manner.

Alternatively or additionally, it is, in turn, optionally possible to arrange a tension member at a distance to the tooth geometry in the cavity and thus also at a distance to the textile layer in the finished drive belt. To this end, after inserting the mould core into the outer mould and prior to injecting the base material, a tension member can be positioned by means of movable auxiliary elements in the cavity of the cast mould at a distance from the textile layer. The auxiliary elements are moved out of the cavity step by step or continuously after injecting a first portion of the base material leaving the tension member behind in the base material.

The tension member is, in the case of this variant, insofar as it is intended, positioned correspondingly to its subsequent position in the drive belt to be produced in the cavity of the tool by means of retaining elements. In order to enable positioning of the tension member in the free space of the cavity, without retaining lugs or the like being required, the retaining elements are mounted movably in the tool and the injection of the base material takes place in at least two steps. The first injection step is carried out such that the respective tension member is temporarily held by the injected base material and maintains this position while the retaining elements are removed from the region of the tension member covered by the base material. In a second injection step, the hollow spaces left behind by the retaining elements now no longer present in the cavity are then closed.

Of course, the removal of the retaining elements and the closing of the hollows left behind by them can also be carried out in more than two partial steps, i.e. for example only so many retaining elements are removed such that the tension member layer securely maintains its target position until the following base material portion is injected in order to fill the volume no longer occupied by the retaining elements after their removal.

Equally obviously, the removal of the retaining elements and the subsequent injection of base material can be carried out in a virtually-continuous step sequence by for example base material being permanently present at the cavity during the removal of the retaining elements and the space becoming free by the removal of the retaining elements from the cavity is immediately re-closed with subsequent base material.

The retaining elements can for example be designed as longitudinally or radially displaceable slides, rods, pins or the like. The retaining elements can be shaped such that a linear contact with the tension member results. To this end, retaining elements can be used in the form of blades, rails or bars. These are in particular suitable if the geometry to be represented on the drive belt is formed on the outer circumferential surface of the mould core. During manufacture, in which the teeth are shaped on the back of the synchronous belt, depending on the shape of the respective tool core, a support ring or a support rail can also be used as the retaining element.

If the drive belt to be produced is supposed to be equipped with a tension member, this can be implemented in a particularly advantageous manner such that the tension member is applied directly on the textile layer. In the case of the production of synchronous belts, the tension member is supported in this manner via the textile layer directly on the tooth end surfaces of the tooth geometry. In the case of direct support on the textile layer, the thickness of the textile determines the position of the tension member in the belt.

In the case of the method according to the invention, the drive belts are also usually produced as windings, whose width is significantly larger than the target width of an individual, finished drive belt. The drive belts are, in this case, divided from the windings as usual in a tailoring step with the width provided for the respective intended use.

In the event that synchronous belt are supposed to be produced with the invention, synchronous belts with a toothing on the back side or the inside opposite the back side or on both sides (DL synchronous belts) can be produced in the previously-explained manner.

As already mentioned above, in the case of production of drive belts with outer geometry to be represented on the back of the drive belt, in particular tooth geometry, the respectively obtained belt is, if necessary, turned inside out after the shaping production in order to change the previously outer geometry represented on it, i.e. in particular a tooth geometry, to the inside. If the sleeve obtained after the shaping is too wide or rigid for such a change, this work step can optionally be carried out after tailoring the drive belts.

In drive belts produced according to the invention, in particular synchronous belts, the tension members can consist of the following materials:

Steel wires, steel strands, glass fibres, high-performance fibres, such as aramid, carbon fibres, polyester fibres or alternative materials with comparable loadability, such as hybrid tension members which are formed by two or a plurality of different materials such as carbon and glass fibres.

Irrespective of how and where the tension members are positioned in the casting mould, they can for example be inserted into the tool as individual fibres, as a strand, as a winding or as laid fabric. In order to adapt the loadability of the tension member layer to the loads occurring during practical use, if necessary the tension members can also be arranged in the cavity of the casting mould in a single or multi-layered manner.

From a manufacture point of view and with respect to the desired properties of the drive belt to be produced, it may, however, also be advantageous to design the tension member as a textile blank. This textile is preferably designed such that its warp and weft threads define openings which are large enough that the base material can penetrate through them. In the case of such an open-pore textile penetrated by the base material in the finished belt, an intensive interlocking of the tension member with the base material is easily guaranteed which ensures that the forces loaded on the belt during operation are safely absorbed by the tension member.

The textile forming the tension member can be produced from glass fibres, aramid fibres, carbon fibres, polyester fibres, steel wires, steel strands or another material suitable as a tension member that has sufficient strength and flexibility. Of course, different fibres can be combined with one another to enable optimal behaviour of the tension member under the loads occurring during use. It may thus for example be expedient to combine high-strength fibres with particularly flexible fibres to achieve a similarly high flexibility of the tension member with high tensile loadability.

The textile blank may be a hose textile, in particular hose fabric tailored directly for the respective belt length.

The textile blank may, however, also be designed as a flat textile. In this case, the textile blank may be arranged as a web of defined width wound in a spiral manner in the cavity of the casting mould.

The tension member textile blank is arranged in the cavity of the casting mould such that it forms a hose. The joint area, i.e. the area at which the edges of the textile blank assigned to one another meet one another in the blank arranged in the cavity, can be carried out with a straight joint aligned parallel in relation to the longitudinal axis of the mould core or the outer mould or a joint aligned inclined in relation to the longitudinal axis of the mould core and outer mould. The joint edge can be shaped linearly or have a repeatedly jagged, undulating or otherwise irregular course. It may also be expedient to join the tension member textile blank with its edges not in an edge joint but overlapping if this proves favourable with respect to the respective connection method.

The edges of the tension member textile blank abutting one another or overlapping one another can, for example, be connected to one another by sewing, welding (laser/ultrasound) or adhering.

The threads or fibres of the textile blank arranged in the cavity respectively in the circumferential direction have the task, during practical use, of absorbing or transferring the tensile forces loaded on the belt. The fibres or threads aligned parallel to the longitudinal axis of the mould core or the outer mould, in contrast, ensure the position of the fibres or threads aligned in the circumferential direction and thus prevent the tension members slipping when the base material is introduced.

The textile blank is optimally manufactured and aligned in the cavity of the casting mould such that the tension-bearing fibres run in the circumferential direction and orthogonally to the longitudinal axis of the casting mould. The threads or fibres aligned in this direction expediently have a higher tensile and bending fatigue strength than the threads or fibres which are aligned axially-parallel to the longitudinal axis of the casting mould. The threads or fibres in the axial direction have to absorb only the forces occurring in the production process and can be configured to be accordingly weaker.

As already mentioned above, the textile blank does not have to be a fabric in the strictly textile sense which is formed by warp and weft threads interwoven with one another by a suitable weaving technique. In fact, the fibres or threads of the fabric blank arranged at an angle to one another can also be adhered, welded or sewn with one another at their intersection points in the manner of a laid fabric.

In determined application cases, it may be advantageous to also arrange the warp and/or weft threads of the tension member textile blank at an angle in relation to the longitudinal axis of the mould core or the outer mould, which is >0° and <90°. By aligning or designing the textile in a correspondingly diagonal manner, the elasticity of the belt can be targetedly influenced. For example, by arranging the textile threads at an angle of 45°, high elasticity in its longitudinal direction can be imparted to the synchronous belt to be produced. This can also be influenced by the weaving pattern of the textile blank being adapted such that it has a certain elasticity in the loading direction or by spacing the threads or fibres.

Essentially, the rigidity and thus the elongation properties of the drive belt to be produced can be controlled by the tension member materials used, the weaving pattern and the arrangement/alignment of the pattern in the belt.

The textile used according to the invention for the drive belt production, forming the textile layer laid on the geometry to be represented on the belt, in particular tooth geometry may consist of polyamide (nylon) or an alternative material. The respective textile may optionally contain components, such as Teflon threads which reduce friction during use.

The textile forming the textile layer or in the case where a tension member textile blank is used, this textile blank can comprise a labelling device which clearly identifies the drive belt as a passive element when the completely produced drive belt is used and/or as an active element detects at least one property or at least one state of the belt and sends it to a signal detection device.

In addition to the tension member and/or the textile, additional fitting elements can be introduced into the drive belt to be produced in the method according to the invention. It is for example possible to introduce a labelling device into the belt, which enables the respective drive belt to be clearly identified. This labelling device can be designed as an active element which detects certain properties of the belt and notifies a signal detection device. This device is then, in turn, connected to an evaluation device which generates information on the status, life span etc. of the synchronous belt to be monitored in this manner based on the data recorded. A correspondingly designed belt drive and a method for monitoring such a drive are described in the German patent application 10 2015 107 177.0 dated 7 May 2015, whose content is hereby incorporated into this application.

Active transmitters for signal transfer, for example so-called RFIDs and sensors used for detecting the respective property variables periodically require an energy supply for their operation. For this purpose, an energy generating unit can be incorporated in a manner known per se into the drive belt produced according to the invention, such as for example a piezo element which generates electric energy for example from the deformation to which the drive belt is exposed during use or generates electric energy by separate excitation, for example by induction of an electric field, by ultrasound or the like. The energy supply device then has to be electrically-conductively connected to the respective active component.

Similarly, the different components optionally provided in the drive belt produced according to the invention can be wired together or some of these components can be provided with wiring. This wiring can for example also be used as antenna to send or receive signals.

For these wiring applications, electrically-conductive wires can be incorporated into the textile incorporated according to the invention in a drive belt produced according to the invention (tooth-side, textile layer located on the exterior of the drive belt, tension member, tension member textile blank). These conductive materials can be used to transfer signals and energy, however, they can also be used as sensors themselves. Wires can be incorporated into the textile in such a way that the respective wire is destroyed when a defined elongation limit of e.g. 0.1% is exceeded. If a current is guided through this wire, the signal fails upon the wire breaking. The failure of the signal is detected and is a measure for the intended elongation limit being exceeded. This can be evaluated as the signal for when the belt has become overloaded during use and therefore has to be replaced. The electric resistance of the lines is also changed with the elongation. Conclusions can thus be drawn regarding present elongations and the applied force by detecting the resistances.

Heating wires or more extensive heating textile sections can be included in the textile for the textile layer according to the invention provided on the tooth side or the optionally-provided tension member textile blank. The synchronous belt can be held at a defined minimum temperature independently of the environmental temperature using the heating device formed by these heating wires or heating textile sections. This may be expedient when the belt is supposed to be used at low temperatures in order to ensure optimal operating behavior with sufficient continuous loadability even at these temperatures.

An elastomer can be used as the base material for the purposes according to the invention in the case of which it may be a polyurethane (duroplast or thermoplast), rubber, silicone or another material suitable for use as the base material for the drive belt production and usable for injection moulding. Of course, mixtures or combinations of these materials can also be used.

It is also conceivable to introduce in work step g) a first base material into a first area of the cavity and a second base material into a second area of the cavity which is distinguished from the first base material in at least one mechanical property in the case of the completely produced drive belt. In this case, different base materials are introduced at different areas of the drive belt to achieve properties different to one another in the areas in question.

In the case of producing a synchronous belt, it may for example be expedient to form the teeth of the synchronous belt from a comparatively hard and resistant base material and the belt back carrying the teeth from a more elastic material which allows a large number of bending cycles of the belt back.

Similarly, the material of the belt back can also be designed such that it provides a comparatively high frictional resistance at its free top side and thus has grip properties such as for example are typically found with flat belts. Alternatively, it is similarly possible to also manufacture the belt back from a highly-loadable, comparatively rigid material and to optionally profile it on its free top side. The belt back can hereby also be used for force transfer, in any form. It is similarly conceivable to manufacture the belt back in multiple layers from different materials to also achieve an optimised property distribution adapted to the respective requirements.

In principal, the injection molding result is independent of gravity such that the tool can be aligned horizontally or vertically in any position.

Depending on the fill properties of the base material, it may be expedient to carry out the injection from one or both end sides of the tool cavity, from the outside of the tool cavity assigned to the belt back and/or from the opposing inside of the drive belt to be produced.

Like in the case of the tension member layer, there is also the danger of slippage in the case of the textile assigned to the geometry to be represented when introducing the base material into the cavity of the casting mould. It may therefore be advantageous to fix the textile of the textile layer into the regions of the casting mould assigned to the end sides of the mould core prior to injecting the base material into the cavity. In particular in the case of the production in connection with a vacuum generated in a toothing of the mould, it is also helpful to seal at least the region provided with the tooth geometry with respect to the environment so that as little external air as possible is drawn through or around the textile on the vacuum side. To this end, the casting mould can be provided with sealing or clamping elements in the region of the end sides by means of which the respectively required sealing or the respectively required holding of the respective textile layer can be achieved.

In order to optimise the tool costs, different variants of injection moulding tools suitable for the purposes according to the invention are possible.

Depending on the shrinkage behaviour of the respectively used base materials, differently dimensioned tools may be required for identical belt shapes. However, it is also conceivable to control the different shrinkage behaviours occurring from base material to base material via targeted control of the process parameters, such as “injection pressure”, “injection temperature”, “design, number or arrangement of the injection openings in the casting mould”, “alignment of the material flow flowing into the cavity”, “flow speed of the material flow”, “duration of subsequent pressure” or “degree of subsequent pressure” such that a single form can be used for different materials in spite of the different processing behaviour. By providing a suitable control device, the suitable process parameters can be stored in the controller for each belt and base material type.

By means of the invention, drive belts can be produced, which comprise a base body, which comprises a section provided with a determined geometry which comes into contact with another component during use, a textile layer with which the geometry is covered on at least one side and optionally a tension member embedded in the base body and according to the invention is characterised in that the textile layer is exposed to the environment in the brand-new state of the drive belt in the region of the geometry represented on the drive belt and is bonded directly to the base material of the base body on its side facing the base body.

In the case of synchronous belts produced according to the invention, the tooth bases between the teeth of the drive belt adjacent to one another are notch-free, i.e. without a groove formed into the tooth base and aligned transverse to the longitudinal extension of the belt, for example as a result of the coiling nose, which is unavoidable according to the prior art. This also applies to such synchronous belts in which the tension member abuts directly on the textile layer in the region of the tooth base of the tooth geometry formed on the synchronous belt.

The invention therefore relates to methods for producing drive belts from different materials by means of casting processes. To this end, a mould core and an outer mould of a casting tool are provided. The circumferential surface of the mould core or the inner circumferential surface of the outer mould is provided with a geometry to be represented on the drive belt. A textile layer is placed on the geometry. The mould core is placed into the outer mould such that the mould core and the outer mould delimit a cavity between them. Optionally, a tension member can be arranged in the cavity and the cavity can be sealed with respect to the environment at least in the region of the geometry to be represented on drive belt. The textile layer is applied to the surfaces delimiting the geometry and an elastomer base material introduced into the cavity. Optionally, the base material is pressed after filling the cavity and the pressure acting on the base material is maintained until the base material is firm. The belt winding obtained is demoulded and the synchronous belt is optionally divided.

The invention will be explained further below based on a drawing representing an exemplary embodiment. They schematically show:

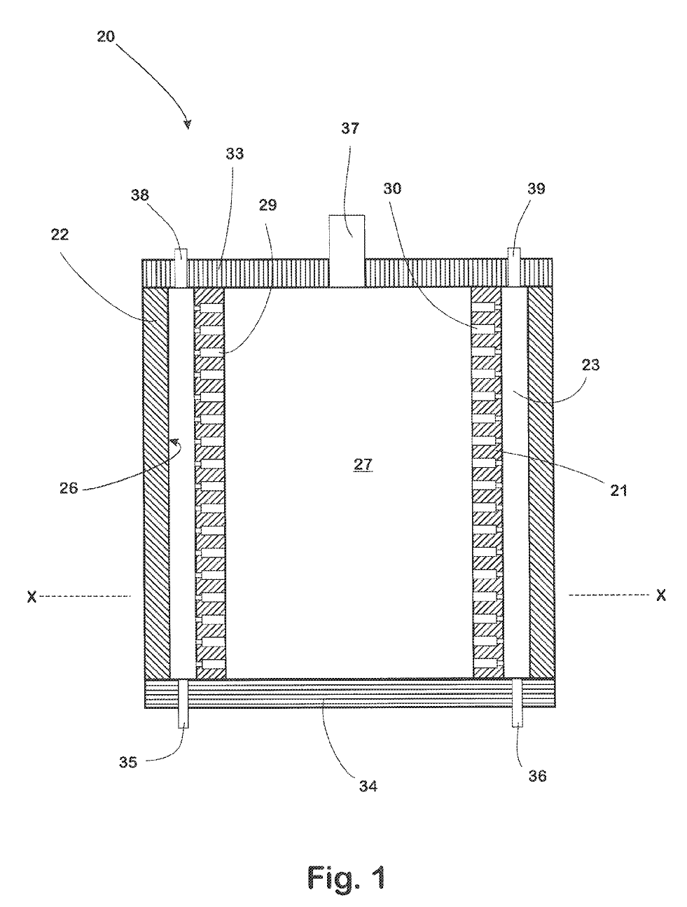

FIG. 1 a casting tool in longitudinal section,

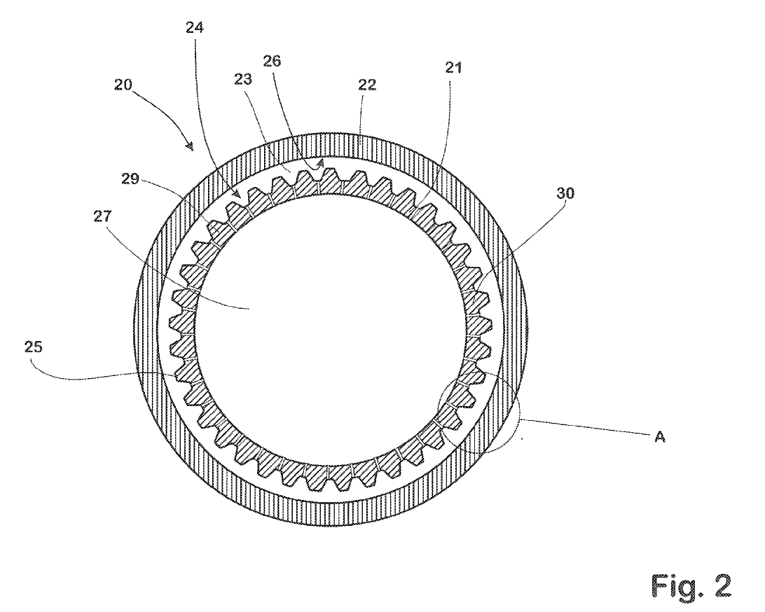

FIG. 2 the tool according to FIG. 1 in a section along the section line X-X plotted in FIG. 1 and

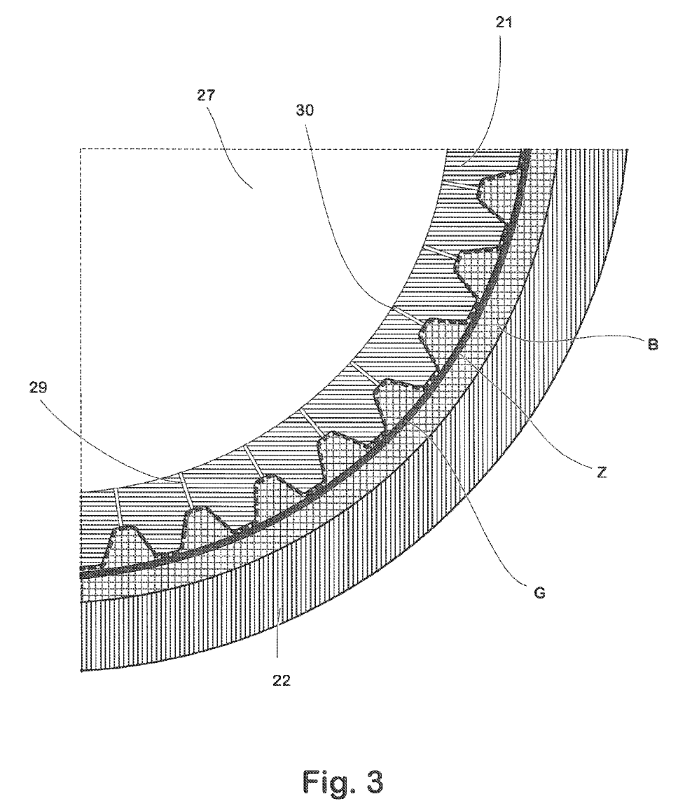

FIG. 3 a cut-out A of FIG. 2;

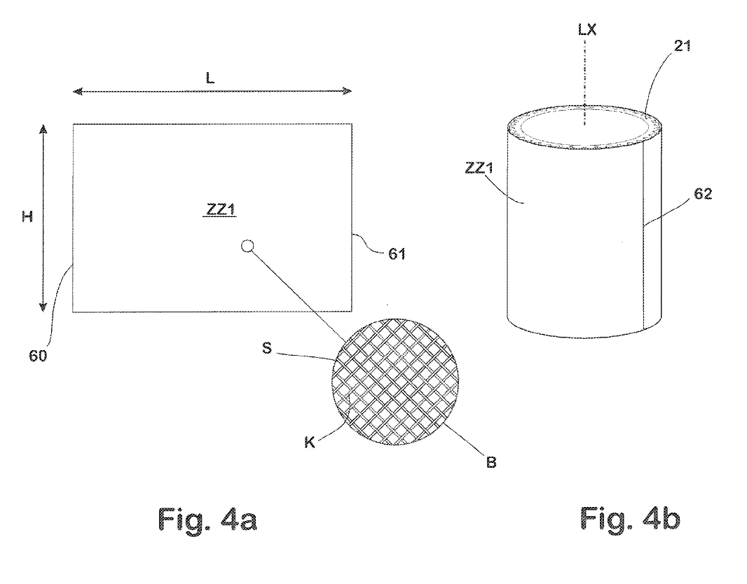

FIG. 4a a first tension member fabric blank;

FIG. 4b the fabric blank according to FIG. 4a in a state applied to the core of the casting tool;

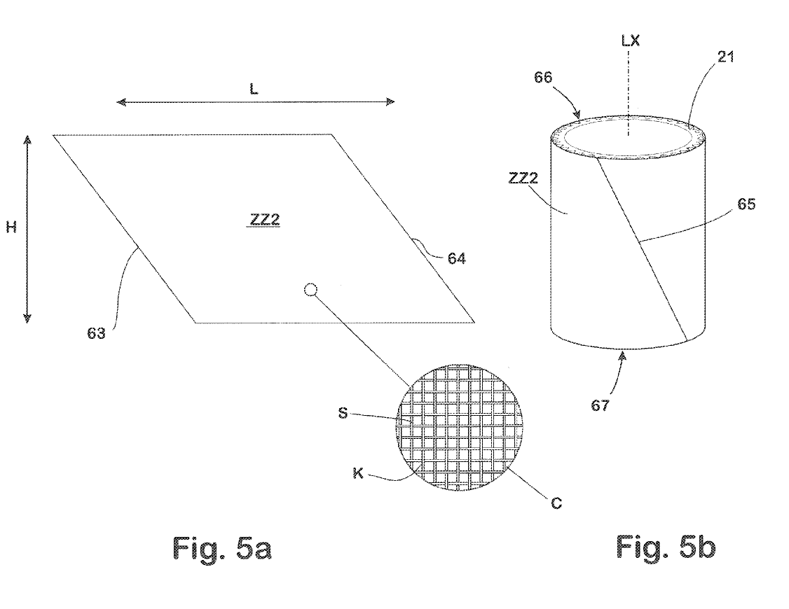

FIG. 5a a second tension member fabric blank;

FIG. 5b the fabric blank according to FIG. 5a in a state applied to the core of the casting tool;

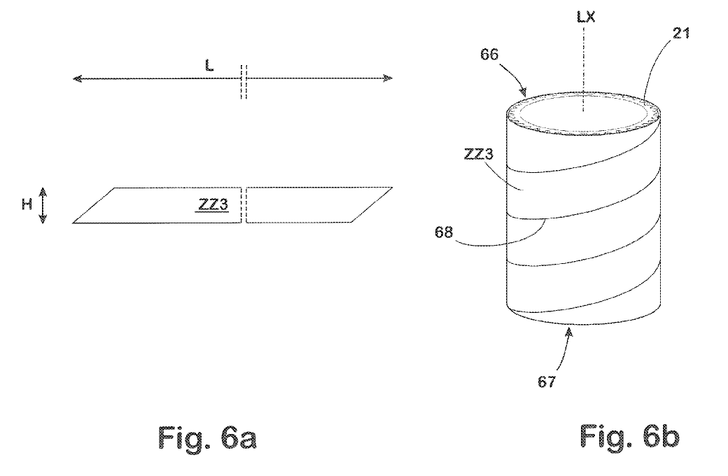

FIG. 6a a third tension member fabric blank;

FIG. 6b the fabric blank according to FIG. 6a in a state applied to the core of the casting tool;

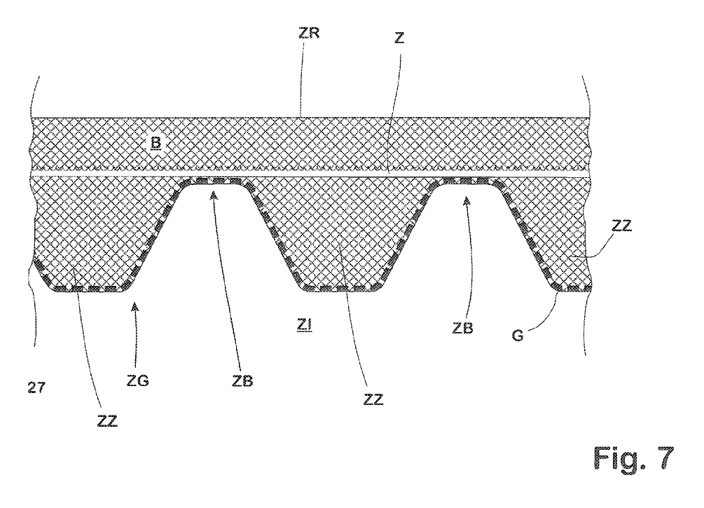

FIG. 7 a cut-out of a synchronous belt produced according to the invention in a longitudinal section.

The injection moulding tool 20 has a tubular core 21 and an outer shell 22, the core 21 carrying on its circumference 24 assigned to the cavity 23 of the tool 20 a toothing 25 forming the “tooth geometry” of the core 21 and the inner surface 26 of the outer shell 22 assigned to the cavity 23 is formed flat.

The core 21 surrounds a central evacuation line 27. A large number of suction lines 29, 30 are guided through the wall of the core 21 from the central evacuation line 27 to the circumference of the core 21.

The suction lines 29, 30 discharge into the tooth bases of the tooth geometry provided at the circumferential surface 24 of the core 21 and are, in this case, distributed such that a uniformly distributed underpressure results at the circumferential surface 24 when the atmosphere (air) present in the cavity 23 is suctioned via the central evacuation line 27.

A textile layer G formed as fabric and a tension member layer Z are inserted into the tool 20 to produce a synchronous belt winding from which a larger number of synchronous belts can subsequently be divided (FIG. 2, 3).

The textile layer G is arranged such that it is located between the toothing 25 and the tension member layer Z. The length of the textile layer G is dimensioned taking into account its elasticity such that it corresponds to the length of the contour line of the toothing 25, the textile layer G can thus be applied to the toothed circumferential surface 24 of the core 21 such that it can cover the circumferential surface 24 of the core 21 without folds and substantially without stresses.

The textile layer G is provided with a coating made of a material which is related to the base material B from which the base body of the drive belt to be produced is supposed to be manufactured. If the base material B is, for example, a PU material, the coating of the textile layer G also expediently consists of a PU material. In this way, the base material B reacts with the coating material of the textile layer G when the base material B is introduced into the cavity 23 and an intensive materially-bonded binding results between the base body formed from the base material B and the textile layer G of the drive belt. The coating of the textile layer G can be carried out such that the individual fibres, of which the textile layer G consists, are provided with the coating or the textile layer G as a whole is provided with a coating. In the latter case, the coating is optimally formed such that the textile layer G is as gas-tight as possible in order to support the application on the geometry to be represented on the drive belt (toothing 25).

As represented in FIG. 3, the tension member layer Z is supported via the textile layer G on the tooth end surfaces of the toothing 25 (“tooth geometry) in the configuration explained here such that no further retaining means are required to position the textile layer G in the cavity 23.

However, if the tension member layer Z is supposed to be positioned in the free space between the toothing 25 and the inner surface 26 of the outer shell 22, retaining elements, not represented here, can be inserted here for this purpose. The tension member layer Z can be held in the cavity 23 by means of these retaining elements such that its position corresponds to the target position in the synchronous belt winding to be produced.

The tension member layer Z is for example a winding, which is formed by winding individual tension member fibres or tension member fibre strands. Alternatively, the tension member layer Z may be a fabric blank ZZ1-ZZ3, as is explained further below in connection with the FIGS. 4a-6d.

After positioning the tension member Z and the textile G, the cavity 23 is sealed by means of a lid 33 which also covers the central evacuation line 27 and has a central suction opening 37 via which the evacuation line 27 and thus the cavity 23 can be evacuated via the suction lines 29, 30. For this purpose, an evacuation device, not shown here, is connected to the suction opening.

The mould core 21 and the outer shell 22 sit on a base 34 on the side opposite the lid 33, said base seals the cavity 23 and the central evacuation line 27 at this side. Injection nozzles 35, 36 are guided through the base 34 by means of which base material B can be injected into the cavity 23.

In order to prevent slipping of the textile layer G during injection of the base material into the cavity on the toothing 25 of the core 21, the textile layer G can be fixed in the region of the end sides of the core 21.

If the cavity 23 is now evacuated via the central evacuation line 27, the textile layer G is suctioned at the predefined tooth contour of the toothing 25 such that the textile G assumes the predefined tooth shape (FIG. 3). The textile G is held and pre-stretched by the vacuum such that it abuts on the tooth geometry of the mould core 21.

Only then does the actual casting process begin. In this case, a first batch of the base material B is injected via the base 34 of the tool into the cavity 23 and in such a way that the tension member layer Z is carried by the injected base material B. Air still present in the cavity 23 and displaced by the base material B can escape via separate air outlets 38, 39.

In the event that retaining elements have been used to position the textile layer G, these are now drawn out of the cavity 23 and, if necessary, an additional batch of the base material B is injected into the cavity 23.

If the cavity 23 is thereby completely filled, the air outlets 38, 39 are sealed. Optionally, a short pressure increase can now be effected. The base material B injected (pressed) with increased overpressure ensures the complete forming of the toothing with textile G and base material B. The air possibly still present between textile G and the tooth geometry can escape via the suction lines 29, 30. The contact of the textile layer G on the surfaces of the toothing 25 assigned thereto is thus perfected and the filling of the cavity 23 similarly optimised.

As already explained above, the tension member Z can also be provided as a fabric blank and be arranged in the cavity 23 of the casting tool 20. The tension member fabric blank can be formed as a hose structure or, as shown in FIGS. 4a-6d, be processed as blank ZZ1, ZZ2, ZZ3 provided from a flat textile fabric.

In the case of the variant represented in FIG. 4a, 4b, the tension member fabric blank ZZ1 has a rectangular shape whose height H corresponds to the height of the core 21 and whose length L corresponds to the circumferential length of the maximum circular diameter of the core 21 defined by the tooth end surfaces of the toothing 25 provided on the core 21 and the textile layer G located thereon. The fabric blank ZZ1 can accordingly be placed around the core 21 such that it, on the one hand, rests tightly on the sections of the textile layer G located on the tooth end surfaces of the toothing 25 and, on the other hand, is joined with its edges 60, 61 connecting its longitudinal sides by an edge joint. The joint line 62 is aligned axially parallel to the longitudinal axis LX of the core 21.

As cut-out B of FIG. 4a shows in an enlargement, the threads or fibres of the fabric blank can be aligned at an angle of, for example, 45° in relation to the longitudinal axis LX in order to give the tension member fabric blank ZZ1 a certain extensibility in the circumferential direction U of the core 21 and therefore give the synchronous belt to be produced a corresponding extensibility. In this case, weft threads S of the fabric blank ZZ1 absorbing the tensile forces loaded on the synchronous belt consist of a high-performance fibre, such as aramid, whereas the warp threads K of the fabric blank ZZ1, which merely ensure the position of the weft threads S, are formed from comparably weak polyester fibres.

In the case of the variant shown in FIG. 5a, 5b, the tension member fabric blank ZZ2 has the shape of a tilted parallelogram whose height H corresponds to the height of the core 21 and whose length L, in turn, corresponds to the circumferential length of the maximum circular diameter of the core 21 defined by the tooth end surfaces of the toothing 25 provided on the core 21 and the textile layer G located thereon. The fabric blank ZZ2 can also accordingly be placed around the core 21 such that it, on the one hand, rests tightly on the sections of the textile layer G located on the tooth end surfaces of the toothing 25 and, on the other hand, is joined with its edges 63, 64 connecting its longitudinal sides by an edge joint. The joint line 65, in this case, runs in a straight line aligned inclined in relation to the longitudinal axis LX of the core 21 from upper 66 to the lower end side 67 of the core 21.

As cut-out C of FIG. 5b shows in an enlargement, the threads or fibres are aligned at an angle of 0° or 90° in relation to the longitudinal axis LX in the blank ZZ2 in order to give the tension member fabric blank ZZ2 maximum tensile strength.

In the case of the variant shown in FIG. 6a, 6b, the tension member fabric blank ZZ3 formed here in a strip shape also has the form of a tilted parallelogram. However, its height H corresponds, for example, only to a fraction, for example one fifth, of the height of the core 21. Its length L is also dimensioned such that the fabric blank ZZ3 can be repeatedly wound in a spiral shape around the textile layer G located on the core 21 starting from the edge of the core 21 assigned to the lower end side 67 until it ends at the edge of the core 21 assigned to the upper end side 66. In this case, the longitudinal edges of the fabric blank ZZ3 abut one another tightly in a joint line 68 circulating in a spiral shape around the core 21 and are also aligned inclined in relation to the longitudinal axis LX of the core 21.

The connection between the edges of the tension member fabric blanks ZZ1, ZZ2, ZZ3 respectively laid around the core 21 respectively abutting in the joint lines 62, 65 and 68 is carried out, for example, by welding by means of a laser.

As a result, a synchronous belt winding is obtained with the invention which has an optimal surface quality free of undesired indents and the like whilst also having optimal property distribution.

Synchronous belts ZR are, in a manner known per se, divided from the synchronous belt winding obtained, whose width corresponds to the respective customer requirements.

Synchronous belts ZR produced according to the invention are characterised in that when they are in the brand-new state, the textile layer G is freely, i.e. not covered by an auxiliary film of base material, arranged on the inside ZI of the synchronous belt ZR provided with the tooth geometry ZG. In this case, the tooth base ZB respectively present between the adjacent teeth ZZ of the tooth geometry ZG is uniform and notch-free although the tension member Z is located directly on the textile layer G here.

### LIST OF REFERENCE NUMERALS

20 injection moulding tool
21 tubular core (mould core)
22 outer shell (outer mould)
23 cavity of the tool 20 (circumferential surface)
24 tooth geometry of the core 21
25 toothing 25 forming the tooth geometry
26 inner surface of the outer shell 22
27 central evacuation line
29, 30 suction lines
33 lid
34 base
35, 36 injection nozzles
37 central suction opening
38, 39 air outlets
60, 61 edges of the tension member fabric blank ZZ1
62 joint line
63, 64 edges of the tension member fabric blank ZZ2
65 joint line
66 upper end side of the core 21
67 lower end side of the core 21
68 joint line
B base material
G textile layer
H height of the tension member fabric blanks ZZ1-ZZ3
K warp threads
L length of the tension member fabric blanks ZZ1-ZZ3
LX longitudinal axis of the core 21
S weft threads
Z tension member layer
ZZ1-ZZ3 tension member fabric blanks
ZR synchronous belt
ZG tooth geometry
ZZ teeth
ZB tooth base

1.-19. (canceled)

20. A method for producing a drive belt, comprising:
a) providing a mould core and an outer mould of a casting tool, wherein the mould core is provided to be inserted into the outer mould such that a cavity representing a shape of the drive belt to be produced is formed between the outer mould and the mould core sitting therein, and wherein a circumferential surface of the mould core assigned to the cavity or the inner circumferential surface of the outer mould assigned to the cavity is provided with a geometry to be represented on the drive belt which is formed by recesses or protrusions which are delimited by surfaces abutting one another which are formed into the circumferential surface of the mould core or the inner circumferential surface of the outer mould or formed on the circumferential surface of the mould core or the inner circumferential surface of the outer mould;
b) placing a textile layer on the geometry to be represented on the drive belt;
c) inserting the mould core into the outer mould so that the mould core and the outer mould define the cavity between them;
d) optionally arranging a tension member in the cavity;
e) optionally sealing the cavity at least in a region of the geometry to be represented on the drive belt with respect to the environment;
f) applying the textile layer on the surfaces which delimit the geometry to be represented on the drive belt on the mould core or on the outer mould, wherein applying the textile layer on the geometry (work step f)) is supported by generating an underpressure in a region of the free spaces which are present between the textile layer and the geometry after work step b);
g) introducing a castable elastomer base material into the cavity;
h) optionally pressing base material after completely filling the cavity with the base material to effect a pressure increase in the cavity;
i) optionally maintaining the pressure acting on the base material until the base material has become sufficiently hard;
j) demoulding a belt winding obtained; and
k) optionally separating the drive belt from the belt winding.

21. The method according to claim 20, wherein the geometry is formed on the circumferential surface of the mould core.

22. The method according to claim 20, wherein the geometry is formed on the inner circumferential surface of the outer mould.

23. The method according to claim 20, wherein the textile of the textile layer is provided with a coating capable of reacting with the base material.

24. The method according to claim 20, wherein the base material is introduced into the cavity with a pressure applied.

25. The method according to claim 20, wherein at least one of the mould core or the outer mould is heated.

26. The method according to claim 20, wherein in work step g) a first base material is introduced into a first area of the cavity and a second base material is introduced into a second area of the cavity, which is distinguished from the first base material in at least one mechanical property in a completely produced drive belt.

27. The method according to claim 20, wherein in order to introduce the tension member into the cavity (work step d)), the tension member is placed around the mould core prior to inserting the mould core into the outer mould (work step c)) and is set together with the mould core into the outer mould.

28. The method according to claim 20, wherein the castable elastomer base material is injected into the cavity in work step g), wherein a tension member is positioned by means of movable auxiliary elements in the cavity of the cast mould at a distance from the textile layer after inserting the mould core into the outer mould and prior to injecting the base material and wherein the auxiliary elements, after injecting a first portion of the base material, are moved out of the cavity step by step or continuously leaving the tension member behind in the base material.

29. The method according to claim 20, wherein the drive belt to be produced is a synchronous belt and wherein the geometry provided on the circumferential surface of the mould core or on the inner circumferential surface of the outer mould assigned to the cavity is a toothed geometry to be represented on the synchronous belt.

30. The method according to claim 28, wherein in work step d) a tension member is placed directly on the textile layer previously placed on the geometry such that said tension member is supported via the textile layer on the toothed end surfaces of the toothed geometry.

31. The method according to claim 20, wherein the tension member is formed as a textile cut-out.

32. The method according to claim 31, wherein threads of the tension member textile cut-out are arranged at an angle in relation to the longitudinal axis of the mould core which is >0° and <90°.

33. The method according to claim 31, wherein the tension member textile cut-out is formed in the manner of a hose.

34. The method according to claim 31, wherein the tension member textile cut-out is formed in shape of a strip and is applied to the geometry in one winding or a plurality of windings.

35. The method according to claim 20, wherein the castable elastomer base material is injected into the cavity in work step g) and in that the geometry-side textile layer or the tension member is fixed on regions of the cast mould assigned to end sides of the mould core prior to injecting the base material into the cavity.

36. The method according to claim 20, wherein the tension member or the textile insert comprises a labelling device which clearly identifies the drive belt as a passive element when the completely produced drive belt is used and/or as an active element detects at least one property or at least one state of the drive belt and sends detected information to a signal detection device.
